(19) United States
(12) Patent Application Publication
(10) Pub. No.: US 2022/0206437 A1
(43) Pub. Date: Jun. 30, 2022

(54) Hand or Composition, Hand, Watch, and Method for Processing Hand or Composition

(71) Applicant: Seiko Epson Corporation, Tokyo (JP)

(72) Inventors: Kazunori HOSHINO, Matsumoto (JP); Ami KUGIMOTO, Shiojiri (JP)

(21) Appl. No.: 17/560,439

(22) Filed: Dec. 23, 2021

(30) Foreign Application Priority Data
Dec. 24, 2020 (JP) 2020-214754

(51) Int. Cl. G04B 19/04; B23K 26/361; B23K 26/359

(52) U.S. Cl. CPC G04B 19/042; B23K 26/359; B23K 26/361

(57) ABSTRACT

A minute hand includes an upper surface, a lower surface that is in a front-back relationship with the upper surface, and a first side surface coupling the upper surface and the lower surface, and the first side surface is provided with decoration including a recess and a protrusion.

The present application is based on, and claims priority from JP Application Serial Number 2020-214754, filed Dec. 24, 2020, the disclosure of which is hereby incorporated by reference herein in its entirety.

### BACKGROUND

### 1. Technical Field

The present disclosure relates to a hand or a composition, a hand, a watch, and a method for processing the hand or the composition.

### 2. Related Art

Watches that indicate time by an indicator, such as a composition arranged on a dial, and a hand, such as an hour hand and minute hand are widely used. JP-A-2017-211385 discloses a hand having a decorated surface. Micro-machining is performed on the upper surface of the hand. The hand has a pattern in the form of reliefs or facets by the micro-machining.

JP-A-2017-211385 discloses a decoration method for providing the pattern on the upper surface of the hand. However, in the decoration method of JP-A-2017-211385, since the micro-machining is performed only on the upper surface, it may be difficult to add decoration having a visual three-dimensional effect to the hand.

### SUMMARY

A hand or a composition includes an upper surface, a lower surface that is in a front-back relationship with the upper surface, and a side surface coupling the upper surface and the lower surface, and the side surface is provided with decoration including a recess and a protrusion.

A hand includes an upper surface, a lower surface that is in a front-back relationship with the upper surface, and a side surface coupling the upper surface and the lower surface and provided with decoration including a recess and a protrusion, and the hand includes a tip portion and a body portion, and in a side view from a direction orthogonal to a normal line of the upper surface, the side surface of the tip portion has a higher density of the recess and the protrusion than that of the side surface of the body portion.

A watch includes the above-described hand or composition.

A method for processing a hand or a composition that includes an upper surface, a lower surface that is in a front-back relationship with the upper surface, and a side surface coupling the upper surface and the lower surface, and the side surface is provided with decoration including a recess and a protrusion. The method includes irradiating the side surface with a laser to form the recess and the protrusion, thereby adding the decoration including the recess and the protrusion to the side surface.

### BRIEF DESCRIPTION OF THE DRAWINGS

FIG. 1 is a schematic view illustrating a configuration of a watch according to a first embodiment.

FIG. 2 is a schematic plan view illustrating structure of a minute hand.

FIG. 3 is a schematic side sectional view illustrating the structure of the minute hand.

FIG. 4 is a schematic side view of a main part illustrating the structure of the minute hand.

FIG. 5 is a schematic side view of a main part illustrating the structure of the minute hand according to a second embodiment.

FIG. 6 is a schematic side view of a main part illustrating the structure of the minute hand according to a third embodiment.

FIG. 7 is a schematic side view of a main part illustrating the structure of the minute hand according to a fourth embodiment.

FIG. 8 is a schematic side view of a main part illustrating the structure of the minute hand according to a fifth embodiment.

FIG. 9 is a schematic side view of a main part illustrating the structure of the minute hand according to a sixth embodiment.

FIG. 10 is a schematic side sectional view illustrating the structure of the minute hand according to a seventh embodiment.

FIG. 11 is a schematic side sectional view illustrating the structure of the minute hand according to an eighth embodiment.

FIG. 12 is a schematic side sectional view illustrating the structure of the minute hand according to a ninth embodiment.

FIG. 13 is a schematic side sectional view illustrating the structure of the minute hand according to a tenth embodiment.

FIG. 14 is a schematic side sectional view illustrating the structure of the minute hand according to an eleventh embodiment.

FIG. 15 is a schematic side sectional view illustrating the structure of the minute hand according to a sixth embodiment.

FIG. 16 is a schematic view for describing a method for processing decoration using a laser.

### DESCRIPTION OF EXEMPLARY EMBODIMENTS

### First Embodiment

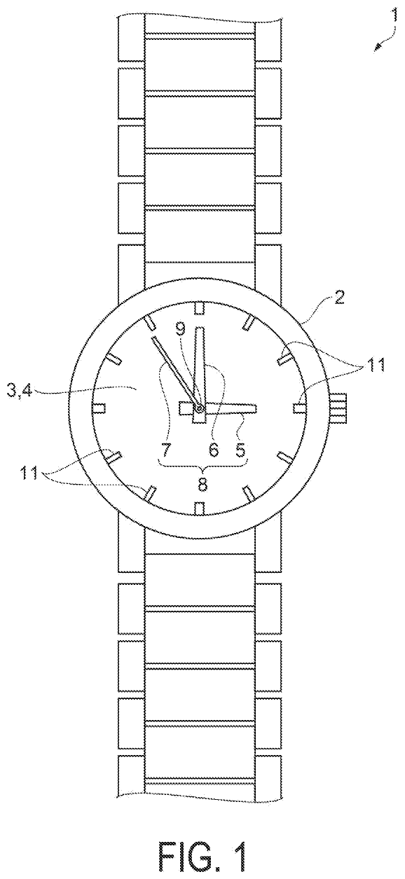

As illustrated in FIG. 1, a watch 1 is a wristwatch. The watch 1 includes an outer case 2 and a windshield glass 3. The watch 1 includes a dial 4, a movement, an hour hand 5, and a hand 8, such as a minute hand 6 and a seconds hand 7 as a hand, in the outer case 2. The hour hand 5, the minute hand 6, and the seconds hand 7 are inserted into a hand shaft 9. The hand 8 is driven by the movement via the hand shaft 9. A composition 11 is arranged on the outer peripheral side of the dial 4. The composition 11 is a scale indicating the amount of movement of the hour hand 5, the minute hand 6, and the seconds hand 7. Next, the hand 8 will be described. Since the hour hand 5, the minute hand 6, and the seconds hand 7 have substantially the same structure, the minute hand 6 will be illustrated and described in this embodiment, and the description of the hour hand 5 and the seconds hand 7 will be omitted.

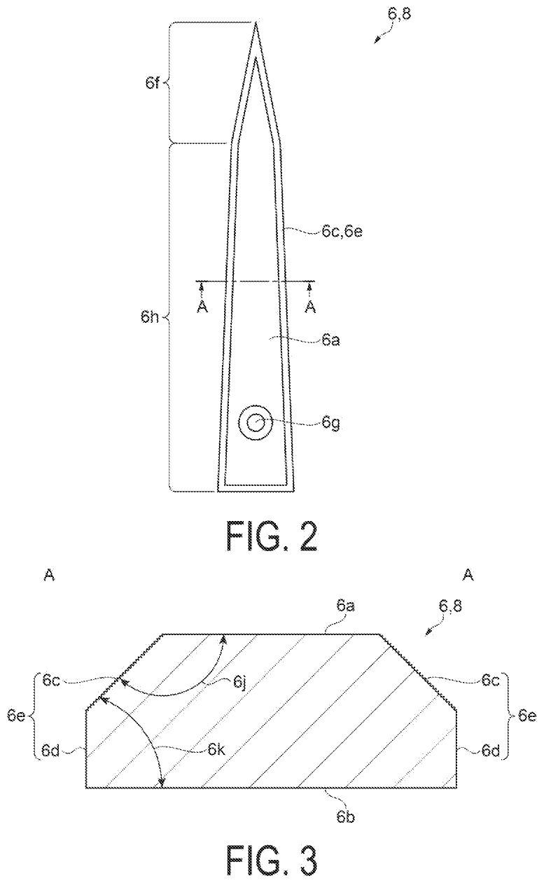

FIG. 2 is a plan view illustrating the structure of the minute hand 6, and FIG. 3 illustrates a cross section taken along a line AA of FIG. 2. As illustrated in FIGS. 2 and 3, one side of the minute hand 6 is sharp. This sharp portion is a tip portion 6f. A rotation center hole 6g is arranged on the opposite side from the tip portion 6f. The rotation center hole 6g of the minute hand 6 is inserted into the hand shaft 9. The minute hand 6 is constituted by the tip portion 6f and a body portion 6h, and a portion at the rotation center hole 6g side than the tip portion 6f is the body portion 6h.

The minute hand 6 includes an upper surface 6a, a lower surface 6b, and a first side surface 6c and a second side surface 6d as a side surface. The upper surface 6a and the lower surface 6b are in a front-back relationship. The upper surface 6a is a surface facing the windshield glass 3. The lower surface 6b is a surface facing the dial 4. The first side surface 6c is a surface inclined with respect to a normal line of the upper surface 6a or a normal line of the lower surface 6b. The second side surface 6d is a surface substantially parallel to the normal line of the upper surface 6a or the normal line of the lower surface 6b. Both the first side surface 6c and the second side surface 6d are a side surface 6e. The side surface 6e is a surface coupling the upper surface 6a and the lower surface 6b. The first side surface 6c is provided with decoration including a recess and a protrusion. Therefore, the side surface 6e is provided with decoration including the recess and the protrusion.

According to this configuration, since the minute hand 6 is provided with the decoration including the recess and the protrusion at the first side surface 6c, the minute hand 6 with more superior appearance can be provided by combination of the upper surface 6a and the decorated first side surface 6c. Further, since the minute hand 6 is provided with the decoration including the recess and the protrusion at the first side surface 6c, the minute hand 6 that looks more three-dimensional can be provided by combination of the upper surface 6a and the decorated first side surface 6c.

The composition 11 may have the same structure as the minute hand 6. The composition 11 with more superior appearance can be provided. Further, the composition 11 that looks more three-dimensional can be provided.

A first angle 6j as an angle formed by the upper surface 6a and the first side surface 6c is an obtuse angle in cross-sectional view from a direction orthogonal to the normal line of the upper surface 6a. A second angle 6k formed by the lower surface 6b and the first side surface 6c is an acute angle. According to this configuration, when viewed from the normal direction of the upper surface 6a, it is easy to see the first side surface 6c than when the angle formed by the upper surface 6a and the first side surface 6c is an acute angle, so that it becomes easier to visually recognize the decoration of the first side surface 6c. The composition 11 may have the same structure as the minute hand 6. The side surface of the composition 11 can also be visually recognized easier.

The upper surface 6a of the minute hand 6 may be a mirror surface. According to this configuration, since the difference in reflectance is large between the mirror surface of the upper surface 6a and the decoration of the recesses and protrusions of the first side surface 6c, it is possible to make the minute hand 6 have superior appearance by contrast between the upper surface 6a and the first side surface 6c. The composition 11 may have the same upper surface as the minute hand 6. It is also possible to make the composition 11 have superior appearance by contrast between the upper surface and the side surface.

The side surface 6e includes a plurality of surfaces of the first side surface 6c and the second side surface 6d. At least one of the plurality of surfaces is provided with the decoration including the recess and the protrusion. In other words, only the first side surface 6c may be provided with the decoration including the recess and protrusion, and the first side surface 6c and the second side surface 6d may be provided with the decoration including the recess and protrusion. According to this configuration, the minute hand 6 with more superior appearance can be provided by the combination of the upper surface 6a and the side surface including the decoration. The composition 11 may have the same structure as the minute hand 6. It is also possible to make the composition 11 have more superior appearance by the combination of the upper surface and the side surface including the decoration.

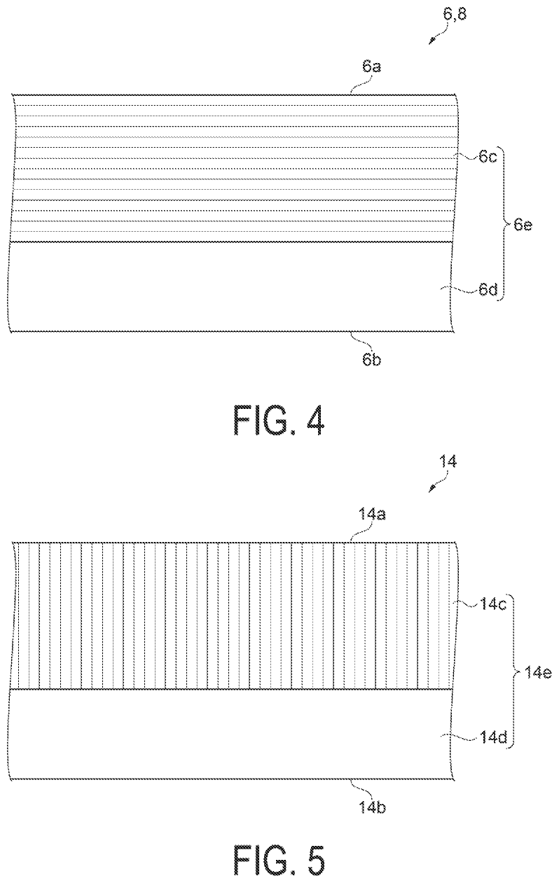

As illustrated in FIG. 4, the decoration including the recess and the protrusion on the first side surface 6c is a hairline constituted by a plurality of linear grooves. The plurality of linear grooves intersect with a direction from the lower surface 6b toward the upper surface 6a. According to this configuration, the minute hand 6 with superior appearance can be provided by the decoration of the plurality of linear grooves that intersect with the direction from the lower surface 6b toward the upper surface 6a. The composition 11 may have the same structure as the minute hand 6. It is also possible to make the decoration of the side surface of the composition 11 have superior appearance.

The watch 1 includes the hand 8 such as the minute hand 6 or the composition 11. According to this configuration, the watch 1 includes the hand 8 or the composition 11. The hand 8 such as the minute hand 6 looks more three-dimensional by the combination of the upper surface 6a and the decorated first side surface 6c. The composition 11 also looks more three-dimensional by the combination of the upper surface and the decorated side surface. Therefore, the watch 1 can be a watch having the hand 8 or the composition 11 that looks three-dimensional.

### Second Embodiment

The present embodiment differs from the first embodiment in that the hair line is oriented differently. Note that configurations identical to those in the first embodiment will be denoted by the same reference signs and redundant descriptions will be omitted.

As illustrated in FIG. 5, a minute hand 14 as a hand includes an upper surface 14a, a lower surface 14b, and a first side surface 14c and a second side surface 14d as a side surface. Both the first side surface 14c and the second side surface 14d are a side surface 14e. The decoration including the recess and the protrusion of the first side surface 14c of the minute hand 14 is a hairline constituted by a plurality of linear grooves. The plurality of linear grooves extend along a direction from the lower surface 14b toward the upper surface 14a. According to this configuration, it is possible to provide the minute hand 14 having a side surface with superior appearance by the decoration of a plurality of linear grooves along the direction from the lower surface 14b to the upper surface 14a. Note that, “along the direction from the lower surface 14b to the upper surface 14a” refers to a state in which a vector component in the direction from the lower surface 14b to the upper surface 14a is large when the direction in which the groove extends is indicated by a vector.

The composition 11 may include the same decoration including the recess and the protrusion as the minute hand 14. The composition 11 can also have excellent appearance by the decoration of a plurality of linear grooves along the direction from the lower surface to the upper surface.

### Third Embodiment

The present embodiment differs from the first embodiment in that the form of the decoration including the recess and the protrusion differ. Note that configurations identical to those in the first embodiment will be denoted by the same reference signs and redundant descriptions will be omitted.

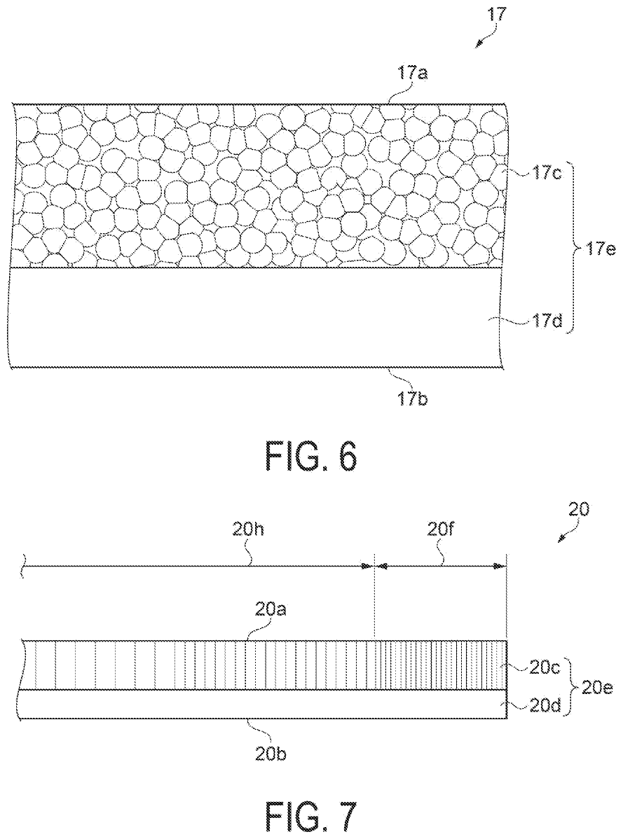

As illustrated in FIG. 6, a minute hand 17 as a hand includes an upper surface 17a, a lower surface 17b, and a first side surface 17c and a second side surface 17d as a side surface. Both the first side surface 17c and the second side surface 17d are a side surface 17e. The decoration including the recess and the protrusion of the first side surface 17c of the minute hand 17 is constituted by a plurality of round recesses. The round recess is formed by, for example, laser irradiation or a sandblasting method. In the sandblasting method, compressed air containing fine particles is applied to the first side surface 17c to form the decoration including the recess and the protrusion on the first side surface 17c. At this time, the upper surface 17a and the second side surface 17d are desirably masked. According to this configuration, it is possible to provide the minute hand 17 having the first side surface 17c with superior appearance by the decoration of the plurality of round recesses.

The composition 11 may include the same decoration including the recess and the protrusion as the minute hand 17. The composition 11 can also have superior appearance by the decoration of the plurality of round recesses.

### Fourth Embodiment

The present embodiment differs from the first embodiment in that the form of the decoration including the recess and the protrusion differ. Note that configurations identical to those in the first embodiment will be denoted by the same reference signs and redundant descriptions will be omitted.

As illustrated in FIG. 7, a minute hand 20 as a hand includes an upper surface 20a, a lower surface 20b, and a first side surface 20c and a second side surface 20d as a side surface. The upper surface 20a and the lower surface 20b are in a front-back relationship. Both the first side surface 20c and the second side surface 20d are a side surface 20e. The side surface 20e couples the upper surface 20a and the lower surface 20b. The first side surface 20c is provided with decoration including a recess and a protrusion.

The minute hand 20 includes a tip portion 20f and a body portion 20h. The tip portion 20f corresponds to the tip portion 6f of the first embodiment, and the body portion 20h corresponds to the body portion 6h of the first embodiment. In a side view from a direction orthogonal to the normal line of the upper surface 20a, the first side surface 20c of the tip portion 20f has a higher density of the recess and the protrusion than the first side surface 20c of the body portion 20h.

The decoration including the recess and the protrusion of the minute hand 20 is a hairline constituted by a plurality of linear grooves. The plurality of linear grooves extend along a direction from the lower surface 20b toward the upper surface 20a. The plurality of linear grooves may intersect with the direction from the lower surface 20b toward the upper surface 20a. In addition, the decoration including the recess and protrusion of the minute hand 20 may be constituted by a plurality of rounded recesses. Further, the first side surface 20c of the body portion 20h may not have the recess and the protrusion, and only the first side surface 20c of the tip portion 20f may have the recess and the protrusion.

According to this configuration, since the minute hand 20 is provided with the decoration including the recess and the protrusion on the first side surface 20c, the minute hand 20 with more superior appearance can be provided by the combination of the upper surface 20a and the decorated first side surface 20c. Further, since the minute hand 20 is provided with the decoration including the recess and the protrusion on the first side surface 20c, the minute hand 20 that looks more three-dimensional can be provided by the combination of the upper surface 20a and the decorated first side surface 20c. Further, since the density of the recess and the protrusion of the first side surface 20c is high at the tip portion 20f of the minute hand 20, the tip portion 20f of the minute hand 20 can be easily visually recognized.

### Fifth Embodiment

The present embodiment differs from the first embodiment in that the form of the decoration including the recess and the protrusion differ. Note that configurations identical to those in the first embodiment will be denoted by the same reference signs and redundant descriptions will be omitted.

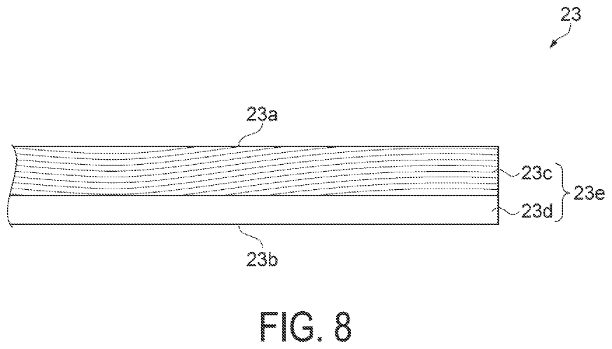

As illustrated in FIG. 8, a minute hand 23 as a hand includes an upper surface 23a, a lower surface 23b, and a first side surface 23c and a second side surface 23d as a side surface. The upper surface 23a and the lower surface 23b are in a front-back relationship. Both the first side surface 23c and the second side surface 23d are a side surface 23e. The side surface 23e couples the upper surface 23a and the lower surface 23b. The first side surface 23c is provided with decoration including a recess and a protrusion.

The decoration including the recess and the protrusion of the first side surface 23c of the minute hand 23 is a hairline constituted by a plurality of linear grooves. The plurality of linear grooves include a curve. A portion of the plurality of linear grooves goes from the lower surface 23b toward the upper surface 23a. A portion of the plurality of linear grooves goes from the upper surface 23a toward the lower surface 23b.

According to this configuration, since the minute hand 23 is provided with the decoration including a curve on the first side surface 23c, the minute hand 23 that shows different facial expressions depending on the viewpoint can be provided.

### Sixth Exemplary Embodiment

The present embodiment differs from the first embodiment in that the decoration on the upper surface and the side surface is different. Note that configurations identical to those in the first embodiment will be denoted by the same reference signs and redundant descriptions will be omitted.

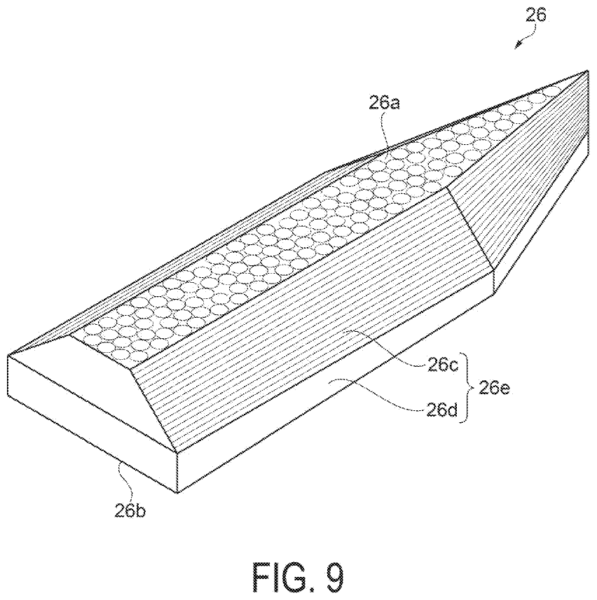

As illustrated in FIG. 9, a minute hand 26 as a hand includes an upper surface 26a, a lower surface 26b, and a first side surface 26c and a second side surface 26d as a side surface. The upper surface 26a and the lower surface 26b are in a front-back relationship. Both the first side surface 26c and the second side surface 26d are a side surface 26e. The side surface 26e couples the upper surface 26a and the lower surface 26b.

The upper surface 26a and the first side surface 26c is provided with decoration including a recess and a protrusion. The decoration including the recess and the protrusion of the upper surface 26a of the minute hand 26 is constituted by a plurality of round recesses. The decoration including the recess and the protrusion of the first side surface 26c of the minute hand 26 is a hairline constituted by a plurality of linear grooves. The plurality of linear grooves intersect with a direction from the lower surface 26b toward the upper surface 26a.

The upper surface 26a includes decoration different from that of the first side surface 26c. According to this configuration, since the kinds of decorations on the upper surface 26a and the first side surface 26c are different, it is possible to make the minute hand 26 have superior appearance by the contrast between the upper surface 26a and the first side surface 26c.

In addition to the plurality of round recesses, a plurality of linear grooves, and platings with color of gold, silver, and the like, can be applied to the decoration of the upper surface 26a including the recess and the protrusion. The decoration of the upper surface 26a including the recess and the protrusion may be processed by laser irradiation, or other processing methods, for example, such as sandblasting, fine stamping processing, and cutting processing may be performed. When the first side surface 26c includes the decoration of the plurality of round recesses, the decoration including the recess and the protrusion of the upper surface 26a may be the hairline constituted by the plurality of linear grooves.

The composition 11 may include the same decoration including the recess and the protrusion as the minute hand 26. The composition 11 can also have superior appearance by the contrast between the upper surface and the side surface.

### Seventh Exemplary Embodiment

The present embodiment differs from the first embodiment in that the side surface is constituted by one surface. Note that configurations identical to those in the first embodiment will be denoted by the same reference signs and redundant descriptions will be omitted.

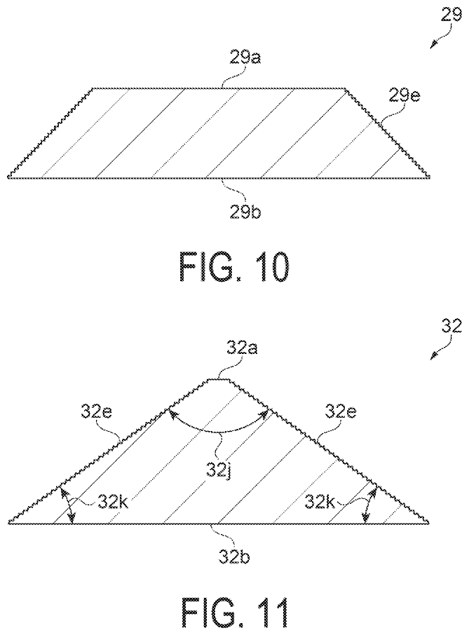

As illustrated in FIG. 10, a minute hand 29 as a hand includes an upper surface 29a, a lower surface 29b, and a side surface 29e. The upper surface 29a and the lower surface 29b are in a front-back relationship. The side surface 29e couples the upper surface 29a and the lower surface 29b. The side surface 29e is constituted by one surface.

The side surface 29e of the minute hand 29 is provided with decoration including a recess and a protrusion. The decoration including the recess and the protrusion of the side surface 29e of the minute hand 29 is a hairline constituted by a plurality of linear grooves. The decoration including the recess and the protrusion of the side surface 29e of the minute hand 29 may be constituted by a plurality of round recesses. At this time as well, the minute hand 29 can have excellent appearance. Similar to the minute hand 29, the side surface of the composition 11 may be one surface. By adding the decoration including the recess and the protrusion to the side surface, the composition 11 can have excellent appearance.

### Eighth Exemplary Embodiment

The present embodiment differs from the seventh embodiment in that the upper surface is narrow. Note that configurations identical to those in the seventh embodiment will be denoted by the same reference signs and redundant descriptions will be omitted.

As illustrated in FIG. 11, a minute hand 32 as a hand includes an upper surface 32a, a lower surface 32b, and a side surface 32e. The upper surface 32a and the lower surface 32b are in a front-back relationship. The side surface 32e couples the upper surface 32a and the lower surface 32b. The side surface 32e is constituted by one surface. The width of the upper surface 32a is shorter than the width of the side surface 32e when viewed from the normal direction of the upper surface 32a. A first angle 32j, which is the angle formed by the two side surfaces 32e, is an obtuse angle. A second angle 32k, which is the angle formed by the lower surface 32b and the side surface 32e, is an acute angle. As will be described later, the upper surface 32a may be a curved surface or may be a surface as small as possible in cross-sectional view.

The side surface 32e of the minute hand 32 is provided with decoration including a recess and a protrusion. The decoration including the recess and the protrusion of the side surface 32e of the minute hand 32 is a hairline constituted by a plurality of linear grooves. The decoration including the recess and the protrusion of the side surface 32e of the minute hand 32 may be constituted by a plurality of round recesses. At this time as well, the minute hand 32 can have excellent appearance. Similar to the minute hand 32, the upper surface of the composition 11 may be narrow. By adding the decoration including the recess and the protrusion to the side surface, the composition 11 can have excellent appearance.

### Ninth Exemplary Embodiment

The present embodiment differs from the first embodiment in that the upper surface is inclined with respect to the lower surface. Note that configurations identical to those in the first embodiment will be denoted by the same reference signs and redundant descriptions will be omitted.

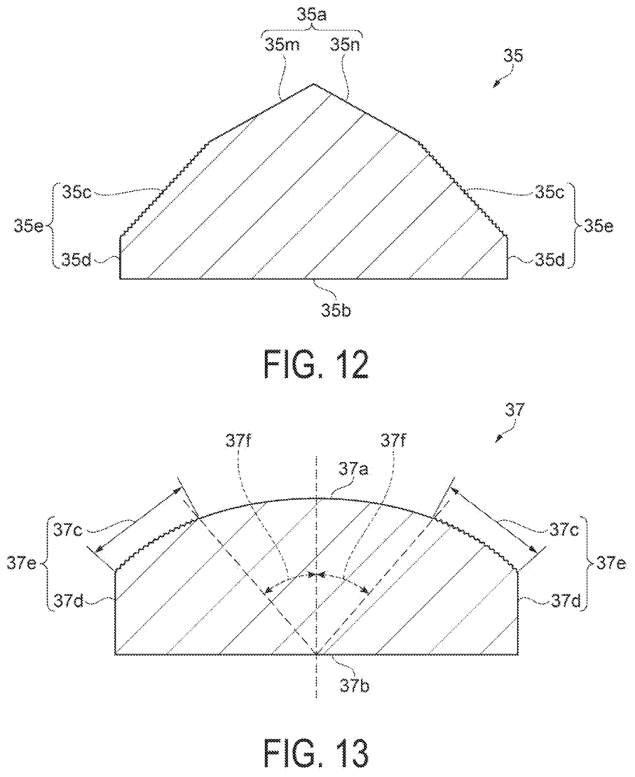

As illustrated in FIG. 12, a minute hand 35 as a hand includes an upper surface 35a, a lower surface 35b, and a side surface 35e. The upper surface 35a and the lower surface 35b are in a front-back relationship. The side surface 35e couples the upper surface 35a and the lower surface 35b. The upper surface 35a is constituted by two surfaces of a first upper surface 35m and a second upper surface 35n. An angle formed by the first upper surface 35m and the second upper surface 35n is an obtuse angle. The first upper surface 35m and the second upper surface 35n are mirror surfaces.

The side surface 35e of the minute hand 35 includes a first side surface 35c and a second side surface 35d as a side surface. The first side surface 35c is a surface inclined with respect to a normal line of the lower surface 35b. The second side surface 35d is a surface substantially parallel to the normal line of the lower surface 35b. The first side surface 35c is provided with decoration including a recess and a protrusion. The decoration including the recess and the protrusion of the first side surface 35c of the minute hand 35 is a hairline constituted by a plurality of linear grooves. The decoration including the recess and the protrusion of the first side surface 35c of the minute hand 35 may be constituted by a plurality of round recesses. At this time as well, when the minute hand 35 is viewed from the direction intersecting with the normal direction of the lower surface 35b, the contrast between the upper surface 35a and the first side surface 35c is different, so that excellent appearance can be obtained. Similar to the minute hand 35, the upper surface of the composition 11 may be an inclined surface. By adding the decoration including the recess and the protrusion to the side surface, the composition 11 can have excellent appearance.

### Tenth Exemplary Embodiment

The present embodiment differs from the first embodiment in that the side surface has a curved surface. Note that configurations identical to those in the first embodiment will be denoted by the same reference signs and redundant descriptions will be omitted.

As illustrated in FIG. 13, a minute hand 37 as a hand includes an upper surface 37a, a lower surface 37b, and a side surface 37e. The upper surface 37a and the lower surface 37b are in a front-back relationship. The side surface 37e couples the upper surface 37a and the lower surface 37b. The side surface 37a is constituted by two surfaces of a first side surface 37c and a second side surface 37d. The first side surface 37c is a curved surface. The first side surface 37c of the minute hand 37 is provided with decoration including a recess and a protrusion. The upper surface 37a is a mirror surface. In the present embodiment, the upper surface 37a is a region separated by a virtual line inclined at a predetermined first angle 37f in the positive and negative directions with respect to a normal line of the lower surface 37b that passes through the apex of the curved surface that is in the front-back relationship with the lower surface 37b. The predetermined first angle 37f is, for example, equal to or less than 80°, and by setting in this manner, visual contrast between the upper surface 37a and the first side surface 37c can be ensured.

The side surface 37e has the curved surface, and the curved surface is provided with decoration including the recess and the protrusion. The decoration including the recess and the protrusion of the first side surface 37c of the minute hand 37 is a hairline constituted by a plurality of linear grooves. The decoration including the recess and the protrusion of the first side surface 37c of the minute hand 37 may be constituted by a plurality of round recesses. Since the contrast between the upper surface 37a and the first side surface 37c is different, excellent appearance can be obtained. According to this configuration, the impression of the minute hand 37 can be softened by providing the decorated curved surface to the minute hand 37. The composition 11 may have the same structure as the minute hand 37. The impression of the composition 11 can also be soften.

### Eleventh Exemplary Embodiment

The present embodiment differs from the tenth embodiment in that the second side surface has a curved surface. Note that configurations identical to those in the first embodiment will be denoted by the same reference signs and redundant descriptions will be omitted.

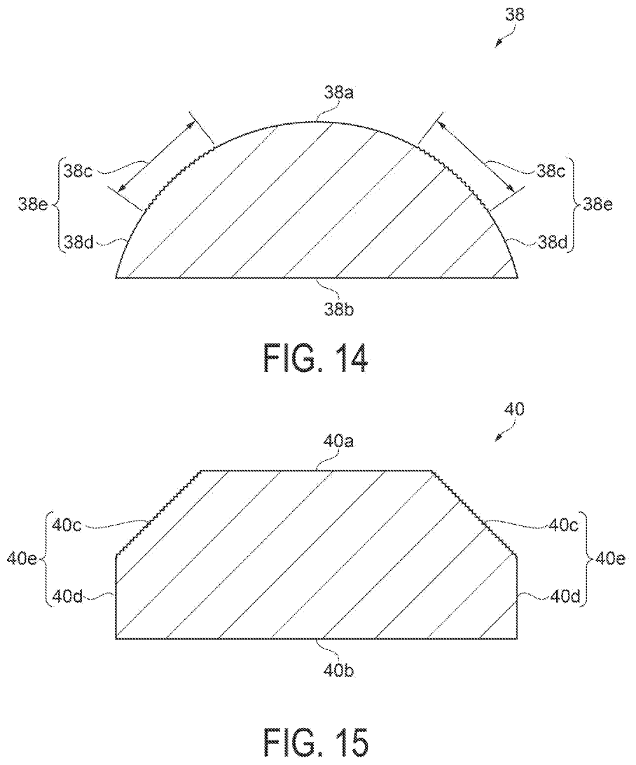

As illustrated in FIG. 14, a minute hand 38 as a hand includes an upper surface 38a, a lower surface 38b, and a side surface 38e. The upper surface 38a and the lower surface 38b are in a front-back relationship. The side surface 38e couples the upper surface 38a and the lower surface 38b. The side surface 38e is constituted by two surfaces of a first side surface 38c and a second side surface 38d as a side surface. The first side surface 38c and the second side surface 38d are curved surfaces. The first side surface 38c of the minute hand 38 is provided with decoration including a recess and a protrusion. The upper surface 38a is a mirror surface.

The side surface 38e has the curved surface, and the curved surface has decoration including the recess and the protrusion. The decoration including the recess and the protrusion of the first side surface 38c of the minute hand 38 is a hairline constituted by a plurality of linear grooves. The decoration including the recess and the protrusion of the first side surface 38c of the minute hand 38 may be constituted by a plurality of round recesses. Since the contrast between the upper surface 38a and the first side surface 38c is different, excellent appearance can be obtained. According to this configuration, the impression of the minute hand 38 can be softened by providing the decorated curved surface to the minute hand 38. Since the first side surface 38c and the second side surface 38d are curved surfaces, the impression of the minute hand 38 can be further softened. The composition 11 may have the same structure as the minute hand 38. The impression of the composition 11 can also be soften.

### Twelfth Exemplary Embodiment

The present embodiment differs from the first embodiment in that the first side surface is processed by a laser. Note that configurations identical to those in the first embodiment will be denoted by the same reference signs and redundant descriptions will be omitted.

As illustrated in FIG. 15, a minute hand 40 as a hand includes an upper surface 40a, a lower surface 40b, and a side surface 40e. The upper surface 40a and the lower surface 40b are in a front-back relationship. The side surface 40e couples the upper surface 40a and the lower surface 40b. The side surface 40e is constituted by two surfaces of a first side surface 40c and a second side surface 40d as a side surface. The first side surface 40c of the minute hand 40 is provided with decoration including a recess and a protrusion. The upper surface 40a is a mirror surface.

The decoration including the recess and the protrusion of the first side surface 40c of the minute hand 40 is formed by irradiation with a laser. In the decoration including the recess and the protrusion, a plurality of linear grooves may be arranged in parallel. The decoration including the recess and the protrusion may have an arrangement in which a plurality of linear parallel grooves intersect. Since the contrast between the upper surface 40a and the first side surface 40c is different, excellent appearance can be obtained. According to this configuration, since the decoration including the recess and the protrusion is formed by irradiation of a laser, it is possible to easily decorate even a fine part as compared with the case of mechanically decorating.

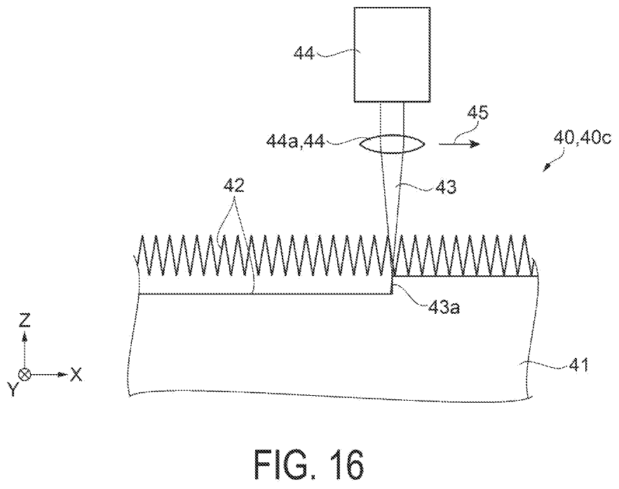

FIG. 16 illustrates a state in which a groove 42 is formed by a laser 43 with respect to a base material 41 of the minute hand 40. As illustrated in FIG. 16, a laser irradiation device 44 emits the laser 43. The focused laser 43 is irradiated on a surface of the base material 41. The groove 42 is formed by irradiating the laser 43 with a pulse having a duration of less than 1 picosecond. A step of forming the groove 42 is performed by advancing the position where the laser 43 is irradiated to the base material 41 in a predetermined scanning direction 45. First, the groove 42 of a first stage is formed.

For the laser 43, for example, a femtosecond laser of a YAG laser is used. The location where the laser 43 is focused by a lens 44a is a light condensing portion 43a. The light condensing portion 43a is moved in the scanning direction 45. The groove 42, that is, the recess and the protrusion are formed at the location where the laser 43 is irradiated.

When it is desired to further deepen the recess and the protrusion or when it is desired to form a recess and a protrusion having a pattern different from that of the groove 42 by the laser 43, the laser 43 is further irradiated. When the groove 42 is irradiated with the laser 43 again, a deeper groove 42 is formed. Note that when a normal direction of the surface of the base material 41 is oblique to the laser 43, for example, when irradiating the side surface of the hand or of the composition with the laser, the laser 43 may be irradiated to the surface of the base material 41 in a state where the normal line of the side surface and the substantial optical axis of the laser do not coincide with each other. Alternatively, the base material 41 may be inclined such that the angle formed by the normal direction of the surface of the base material 41 and the advancing direction of the laser 43 becomes small.

By irradiating the first side surface 40c with the laser 43 to form the recess and the protrusion, the first side surface 40c is decorated with the recess and the protrusion. According to this method, the minute hand 40 having more superior appearance by combination of the upper surface 40a and the first side surface 40c including the decoration can be provided. Further, since the decoration including the recess and the protrusion is formed by irradiation of the laser 43, it is possible to easily decorate even a fine section as compared with the case of mechanically decorating. The composition 11 may also be formed in the same manner as the minute hand 40. A fine section of the composition 11 can also be decorated easily. As described above, in the method for processing the hand 8 or the composition 11, by irradiating the side surface of the hand 8 or the composition 11 with the laser 43 to form the recess and the protrusion, the decoration including the recess and the protrusion is applied to the side surface.

What is claimed is:

1. A hand or a composition comprising:
an upper surface,
a lower surface that is in a front-back relationship with the upper surface, and
a side surface coupling the upper surface and the lower surface, wherein
the side surface is provided with decoration including a recess and a protrusion.

2. The hand or the composition according to claim 1, wherein
in cross-sectional view from a direction orthogonal to a normal line of the upper surface, an angle formed by the upper surface and the side surface is an obtuse angle.

3. The hand or the composition according to claim 1, wherein
the decoration including the recess and the protrusion is a hairline constituted by a plurality of linear grooves, and the plurality of linear grooves intersect with a direction from the lower surface toward the upper surface.

4. The hand or the composition according to claim 1, wherein
the decoration including the recess and the protrusion is a hairline constituted by a plurality of linear grooves, and the plurality of linear grooves extend along a direction from the lower surface toward the upper surface.

5. The hand or the composition according to claim 1, wherein
the decoration including the recess and the protrusion of the side surface is constituted by a plurality of round recesses.

6. The hand or the composition according to claim 1, wherein
the upper surface is a mirror surface.

7. The hand or the composition according to claim 1, wherein
the upper surface is provided with decoration different from that of the side surface.

8. The hand or the composition according to claim 1, wherein
the side surface has a curved surface, and
the curved surface is provided with the decoration including the recess and the protrusion.

9. The hand or the composition according to claim 1, wherein
the decoration including the recess and the protrusion is formed by irradiation with a laser.

10. The hand or the composition according to claim 1, wherein
the side surface includes a plurality of surfaces, and at least one surface is provided with the decoration including the recess and the protrusion.

11. A hand comprising:
an upper surface,
a lower surface that is in a front-back relationship with the upper surface, and
a side surface coupling the upper surface and the lower surface and provided with decoration including a recess and a protrusion, wherein
the hand includes a tip portion and a body portion, and in a side view from a direction orthogonal to a normal line of the upper surface, the side surface of the tip portion has a higher density of the recess and the protrusion than that of the side surface of the body portion.

12. A watch comprising the hand or the composition according to claim 1.

13. A method for processing a hand or a composition, the hand or the composition comprising:
an upper surface,
a lower surface that is in a front-back relationship with the upper surface, and
a side surface coupling the upper surface and the lower surface, wherein
the side surface is provided with decoration including a recess and a protrusion, the method comprising:
irradiating the side surface with a laser to form the recess and the protrusion.
